(19) United States
(12) Patent Application Publication
(10) Pub. No.: US 2010/0247832 A1
(43) Pub. Date: Sep. 30, 2010

(54) Label and Method for Preparing the Same

(75) Inventors: Young-Hee Kim, Gwacheon-si (KR); Han Jun Kang, Suwon-si (KR); Sung-ho Lee, Ansan-si (KR)

Correspondence Address: FENWICK & WEST LLP, SILICON VALLEY CENTER, 801 CALIFORNIA STREET, MOUNTAIN VIEW, CA, 94041, US

(73) Assignee: YOUL CHON CHEMICAL CO., LTD., Seoul (KR)

(21) Appl. No.: 12/670,835

(22) PCT Filed: Aug. 6, 2008
(86) PCT No.: PCT/KR2008/004568

§ 371 Date: Jan. 26, 2010

(30) Foreign Application Priority Data
Aug. 6, 2007 (KR) 10-2007-0078567

(51) Int. Cl. B32B 9/04; B32B 3/26; B32B 33/00; B41M 5/132

(52) U.S. Cl. 428/41.1; 428/41.2; 428/304.4; 428/40.1; 427/154

(57) ABSTRACT

Disclosed is a label comprising a substrate film, or a substrate film and an intermediate film, wherein either or both of the substrate film and the intermediate film have through-holes, and a method for preparing the same. The method for preparing the label causes no generation of defects, and shows an excellent production rate and work efficiency. The label has no possibility of forgery, and shows clear marking characteristics. In addition, the label has a simple structure and excellent printability and cost efficiency, causes no degradation of the quality with time, shows high chemical resistance and heat resistance, is free from various contaminants during use, and is provided with low initial adhesion but high permanent adhesion.

### TECHNICAL FIELD

The present invention relates to a label and a method for preparing the same. More particularly, it relates to a label that prevents forgery of articles related to vehicles, electronic appliances, semiconductors, medical instruments, etc., and allows follow-up management of such articles when they are recalled.

### BACKGROUND ART

For example, a vehicle has its registration number engraved in metallic plates attached to the head and tail thereof. However, since such metallic plates are easily attached to and detached from a vehicle, it is very difficult to find the corresponding vehicle when it is robbed.

Therefore, to provide against robbery or for recall of a vehicle, a plate or sticker including the information about the vehicle manufacturer's nationality, manufacturer's name, location of the corresponding manufacturing plant, registration number, manufacturing year, constitutional elements and other characteristics has to be attached inside of the bumper or on the window of the vehicle.

The plate or sticker is referred to as a so-called “vehicle license label,” and Korean Utility Model Publication No. 124645 discloses a vehicle license label formed of a metallic plate.

However, since the above label consists of a metallic plate, it has problems in that it may be easily corroded even with tiny scratches and it may be easily counterfeited.

DE Patent No. 29913746 discloses a vehicle license label to which an anti-forgery function is given by laminating a first sheet with a second sheet and by half cutting the second sheet.

However, the above method of producing a label is problematic in that it results in a large deviation in thickness after cutting due to the nature of the half cutting process itself and causes generation of inferior articles when a blade is broken by a rebound.

Additionally, a press type or roll type process is used as a half cutting process, but both types of processes have problems of low cutting uniformity and poor production rate.

In addition to the above, the label obtained from the above method still has a possibility of forgery. In other words, since the label is half cut, the label itself is broken when the whole label is peeled off. However, when only the first sheet including the information is peeled off with the second sheet left as it is, and then the first sheet is reattached to another second sheet, forgery of the label may be possible without breaking the whole label.

EP Patent No. 688678 discloses a laser label comprising a plastic support layer, additives including polyester embedded therein, an adhesive layer and a release film.

However, the above label is problematic in that letters and numbers on the label cannot be seen clearly and the label show poor printability upon the laser marking.

U.S. Pat. No. 6,066,437 discloses a label having a metal (e.g. A1) layer to be removed by using a laser.

The above label is advantageous in that it represents letters or numbers to be seen easily by laser irradiation. However, it is problematic in that the label quality decreases with time due to the oxidation of the metal layer. Additionally, since a high-intensity laser is used to remove the metal layer itself, films are easily ruptured, resulting in degradation of the workability. Further, when a worker fails to attach the label to a substrate at a desired position, peeling and reattachment of the label may rupture the label or may leave residue due to the excessively high initial adhesion of the adhesive layer.

### DISCLOSURE OF INVENTION

### Technical Problem

Therefore, the present invention has been made in view of solving the above problems, and it is an object of the present invention to provide a label on which information not only about vehicles but also about various articles, such as electronic appliances, semiconductors or medical instruments, is recorded so that the articles can be prevented from forgery or can be amenable to follow-up management when they are recalled, wherein the label causes no generation of defects, exhibits a high production rate and work efficiency, has no possibility of forgery, and shows clear marking characteristics, as well as a method for preparing the same.

It is another object of the present invention to provide a label having a simple structure and excellent printability and cost efficiency, causing no degradation of the quality with time, showing high chemical resistance and heat resistance, free from various contaminants during use, and provided with low initial adhesion but high permanent adhesion, as well as a method for preparing the same.

### Technical Solution

In accordance with an aspect of the present invention, the above and other objects can be accomplished by the provision of a label comprising a substrate film, or a substrate film and an intermediate film, wherein either or both of the substrate film and the intermediate film have through-holes.

In accordance with another aspect of the present invention, there is provided a label comprising: a substrate film; an ink layer formed on the bottom of the substrate film; an adhesive layer formed on the bottom of the ink layer; an intermediate film formed on the bottom of the adhesive layer; and a glutinous layer formed on the bottom of the intermediate film, wherein either or both of the substrate film and the intermediate film have through-holes.

In accordance with still another aspect of the present invention, there is provided a method for preparing a label, the method comprising the steps of: (i) forming through-holes in a substrate film; (ii) forming an ink layer on the bottom of the substrate film having the through-holes; (iii) forming an adhesive layer on the bottom of the ink layer; (iv) forming an intermediate film on the bottom of the adhesive layer; and (v) forming a glutinous layer on the bottom of the intermediate film.

In accordance with still another aspect of the present invention, there is provided a method for preparing a label, the method comprising the steps of: (i) providing a substrate film; (ii) forming an ink layer on the bottom of the substrate film; (iii) forming through-holes in the substrate film having the ink layer; (iv) forming an adhesive layer on the bottom of the ink layer; (v) forming an intermediate film on the bottom of the adhesive layer; and (vi) forming a glutinous layer on the bottom of the intermediate film.

In accordance with still another aspect of the present invention, there is provided a method for preparing a label, the method comprising the steps of: (i) providing a substrate film; (ii) forming an ink layer on the bottom of the substrate film; (iii) forming an adhesive layer on the bottom of the ink layer; (iv) forming an intermediate film having through-holes on the bottom of the adhesive layer; and (v) forming a glutinous layer on the bottom of the intermediate film.

In accordance with yet another aspect of the present invention, there is provided a method for preparing a label, the method comprising the steps of: (i) providing a substrate film; (ii) forming an ink layer on the bottom of the substrate film; (iii) forming an adhesive layer on the bottom of the ink layer; (iv) forming an intermediate film on the bottom of the adhesive layer; and (v) forming a glutinous layer on the bottom of the intermediate film, wherein through-holes are formed in both of the substrate film and the intermediate film after steps (i)-(iv).

### BRIEF DESCRIPTION OF THE DRAWINGS

FIG. 1 is a schematic view illustrating the structure of the label according to a preferred embodiment of the present invention together with a laser irradiation unit;

FIG. 2 is a schematic view illustrating another preferred embodiment of the present invention, wherein through-holes are formed in the intermediate film;

FIG. 3 is a schematic view illustrating still another preferred embodiment of the present invention, wherein through-holes are formed in both of the substrate film and the intermediate film;

FIG. 4 is a schematic view illustrating the plane of the film on which the inlets of the through-holes exist according to a preferred embodiment of the present invention; and

FIG. 5 is a schematic view illustrating an embodiment wherein the ratio of the through-holes is excessively high so that the substrate film, i.e. the outermost layer causes interlayer separation upon the laser irradiation to the through-holes.

10 through-hole 11: substrate film
12: ink layer 13: adhesive layer
14: intermediate film 15: glutinous layer
16: release film 20: laser emitter
21a: laser irradiation
21c: laser passing through the substrate
21d: laser passing through the ink layer
30: through-hole inlet
31: through-hole outlet 35: plane
L: label 40: interlayer separation phenomenon

### BEST MODE FOR CARRYING OUT THE INVENTION

The above and other features of the present invention will now be described in detail with reference to certain exemplary embodiments thereof illustrated in the accompanying drawings which are given hereinbelow by way of illustration only, and thus are not limitative of the present invention, and wherein:

According to the present invention, an anti-forgery label generally comprises a first film (also referred to as a first sheet), and a second film (also referred to as a second sheet) formed on the bottom of the first film, wherein either or both of the substrate film as the first film and the intermediate film as the second film have through-holes to impart easy-cut characteristics to the label so that the label is broken starting from the through-holes upon the peeling of the label, thereby preventing any possibility of forgery, to obtain an improved production rate and excellent work efficiency as compared to conducting only a half cutting process, and to prevent generation of inferior labels. As used herein, the second film means the intermediate film.

Additionally, the through-holes formed in the label according to the present invention allow heat and vaporized materials generated upon laser marking to pass through the through-holes, thereby preventing an interlayer separation phenomenon caused by the formation of an air layer between two adjacent layers. Further, the through-holes induce complete oxidation of an ink layer to facilitate a change in color of the ink, thereby realizing clear marking, and improved marking efficiency and printability.

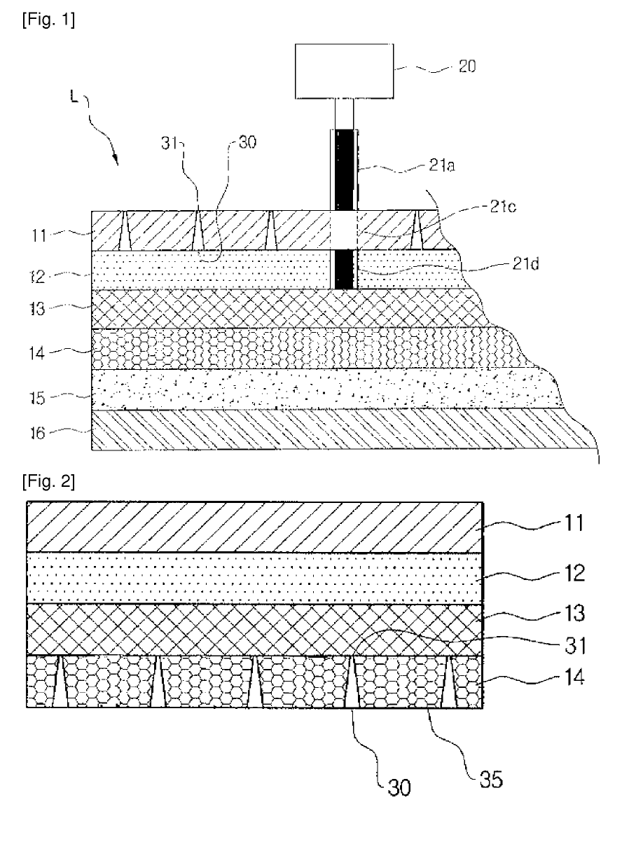

FIG. 1 is a schematic view illustrating the structure of the label according to a preferred embodiment of the present invention together with a laser irradiation unit.

As shown in FIG. 1, the label L according to a first embodiment of the present invention comprises a substrate film 11 and an ink layer 12, particularly an ink layer suitable for laser marking, formed on the bottom of the substrate film.

An intermediate film 14 corresponding to the second film is formed on the bottom of the ink layer 12 with an adhesive layer 13 interposed between the intermediate film and the ink layer.

A glutinous layer 15 is formed on the bottom of the intermediate film 14, and a release film 16 is formed on the bottom of the glutinous layer 15.

The label L having the above described structure is subjected to laser irradiation by way of a laser emitter 20 (as shown in 21a), and the laser beams emitted therefrom pass through the substrate film 11 (as shown in 21c), and then reaches the ink layer 12 (as shown in 21d).

Fine through-holes are formed in the substrate film 11 alone or also in the ink layer 12. Meanwhile, in addition to the formation of the through-holes on the substrate film 11, the substrate film 11 may be subjected to half cutting.

It is also possible to form such fine through-holes in the intermediate film 14, on which a half cutting layer may be further formed.

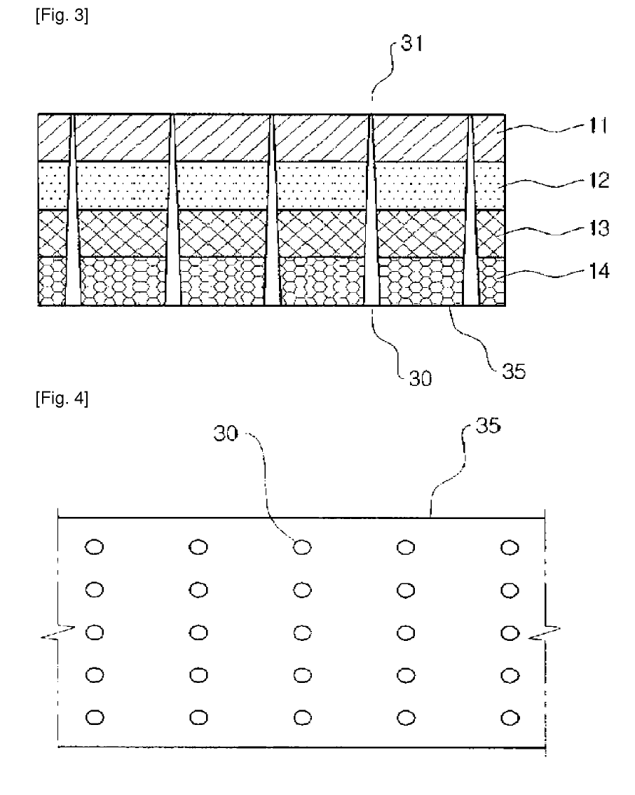

FIGS. 2 and 3 are schematic views illustrating preferred embodiments of the present invention, wherein through-holes are formed in the intermediate film alone (FIG. 2) and both of the substrate film and the intermediate film (FIG. 3), respectively.

With reference to FIGS. 1-3, the through-hole takes the form of a truncated cone wherein the sectional area decreases from the inlet 30 (opening from which point perforation starts) toward the outlet 31 (opening at which point perforation stops).

FIG. 4 is a schematic plan view illustrating the film on which the inlets of the through-holes exist according to a preferred embodiment of the present invention.

With reference to FIG. 4, a ratio of the total area of the surfaces of the through-hole inlets 30 to the area of the plane 35 of the film on which the through-hole inlets exist is defined as a through-hole ratio. Preferably, the ratio of the total area of the surfaces of the through-hole inlets is greater than 0% and equal to or less than 25%, based on the area of the plane of the film on which the through-hole inlets exist in view of the appearance, chemical resistance, and prevention of interlayer separation caused by the materials vaporized upon the laser irradiation (see the following test example).

### MODE FOR THE INVENTION

As described above, since the label according to the film has fine through-holes in either or both of the substrate film and the intermediate film, the film(s) can be totally broken starting from the through-holes formed in the corresponding film when one peels off the film for the purpose of forgery, thereby accomplishing an anti-forgery function.

When the through-holes are formed in both of the substrate film 11 and the intermediated film 14 laminated therewith, the through-holes may be seen from outside the label surface. Therefore, it is advisable to form the through-holes in such a manner that they cannot be seen from the outermost layer of the substrate film. For this, it is preferable to control the through-hole ratio (see the following test example).

In addition to the anti-forgery function, the anti-forgery label having the through-holes as described above functions well in the case where the label is subjected to laser marking.

Particularly, a general laser marking process includes a rapid increase in temperature to 1000° C., resulting in carbonization of the ink composition present in the ink layer of the label or the adhesive present in the adhesive layer of the label. Then, the carbonized products or vaporized materials generated upon the carbonization cannot be emitted from the label and remain between the substrate film and the intermediate film. Thus, an undesired air layer may be formed to cause an interlayer separation phenomenon in the label, leaving soot, and resulting unclear marking.

The through-holes formed in either or both of the substrate film and the intermediate film according to the present invention facilitate heat emission to prevent generation of carbonized and vaporized materials and to enable completion of the oxidation of the ink, thereby accomplishing clear marking and preventing an interlayer separation phenomenon caused by the heat or materials generated upon the laser irradiation in the label. Meanwhile, when only the intermediate film has the through-holes, it may not be possible to emit or discharge the heat or vaporized materials to the exterior. Thus, it is preferable to form the through-holes in the substrate film as well as in the intermediate film.

The ink layer 12 comprises a resin and a pigment, wherein the pigment includes a metal or metal oxide that undergoes oxidation reaction by the laser, resulting in a change in color.

In other words, the laser generates heat while the light energy is converted into the heat energy by the focusing of the light, followed by oxidation of the metal in the ink layer 12 as described hereinafter so that the metal is converted into the oxide thereof. Otherwise, when a metal oxide itself is contained in the ink layer, the metal oxide is converted into another metal oxide having a different oxidation number, or oxidation occurs in such a manner that an incompletely oxidized metal oxide is converted into a completely oxidized one via oxidation, thereby this results in a change in color. A suitable example of the laser includes a YAG laser, which is a low-output laser, particularly applied to a wavelength of 1,064 nm.

As described hereinafter in more detail, the ink layer 12 is preferably formed in a monolayer structure in view of cost-efficiency. However, the ink layer may have a multilayer structure, if necessary.

Hereinafter, a method for preparing labels according to preferred embodiments of the present invention will be described in more detail.

First, a substrate film 11 is provided (S1). Particular examples of the substrate film 11 include a polyolefin film, polyimide film or polyester film. As described above, the method according to the present invention requires laser irradiation, preferably a YAG laser, which causes heat emission. Therefore, a heat resistant film is required. Thus, it is preferred to use a PET film having excellent heat resistance, dimensional stability and processability as the substrate film 11.

Although the substrate film 11 has a thickness that may be controlled depending on the laser intensity, the substrate film preferably has a thickness of 12-150 μm when a YAG laser is irradiated with 1,064 nm. When the substrate film 11 has a thickness less than 12 μm, interlayer separation may occur during the laser processing. On the other hand, when the substrate film has a thickness more than 150 μm, the underlying ink layer 12 cannot undergo a sufficient degree of oxidation reaction under the above laser intensity, so that letters or numbers cannot be clearly represented.

Meanwhile, the top of the substrate film 11 may be subjected to matte-finishing.

Such matte-finishing is required for the surface to be subjected to laser irradiation in order to maximize the marking efficiency upon the laser irradiation and to minimize damages on the label surface caused by light scattering. A particular embodiment of the method for forming such a matte-finished substrate film is as follows.

A resin forming the corresponding substrate film is molded into a sheet, and the sheet is pressurized under a roll having surface irregularities to cause light scattering and to obtain an opaque film.

As a coating process, a resin blend containing an opaque pigment and a urethane acrylic resin is coated through a gravure printing process to form a matte-finished substrate film.

Meanwhile, the substrate film ensures a certain degree of heat resistance (approximately 150° C.) in order to prevent thermal deformation upon the laser irradiation, particularly in the case of a vehicle license label. To ensure such heat resistance, it is preferable to coat the surface of the outermost layer of the substrate film with a resin blend containing a polypropylene resin and a high-density polyethylene resin.

However, when the coating layer of the resin blend on the substrate film is too thick, the ink layer cannot realize its unique color. Thus, it is preferable to perform ultrathin layer coating (greater than 0 μm and equal to or less than 5 μm) via a gravure coating process.

Next, through-holes are formed in the substrate film. To form the through-holes, diamond particles, needles or brushes are attached onto a roll, and the roll is used to form the through-holes in an irregular pattern or a regular linear pattern. The processing rate in the step of forming through-holes is higher as compared to a half cutting process, because the former merely requires the roll passing through the film while the latter requires reciprocation along the longitudinal direction.

Then, an ink layer 12 is formed on the bottom of the substrate film 11.

Herein, a gravure printing or microgravure printing process is preferably used because it is amenable to mass production and reduces the manufacturing cost. Meanwhile, it is preferable to use a cylinder prepared by using laser during the gravure printing or microgravure printing process so as to improve the printing uniformity and laser marking efficiency. Additionally, to maximize the laser marking quality, it is preferable to form the ink layer through ultrathin layer by coating to a thickness greater than 0 μm and equal to or less than 5 μm. When the ink layer has a thickness greater than 5 μm, an unoxidized ink layer may be formed after the laser irradiation. In view of the clear marking, the ink layer 12 preferably has a thickness of 1-2 μm.

The ink layer 12 is for use in realizing a desired letter or number through the oxidation reaction caused by the laser irradiation. In other words, the ink layer 12 according to the present invention comprises ink formed of a pigment containing a metal or metal oxide and a resin. The ink layer 12 may be formed in a monolayer structure. If necessary, the ink layer 12 may be formed in a multilayer structure as mentioned above.

Specifically, the ink used in the ink layer 12 comprises a resin and a pigment, wherein the resin preferably includes an acrylate urethane resin.

The pigment includes a metal that can undergo oxidation reaction by a laser, preferably a YAG laser, and more preferably a metal oxide that undergoes a change in oxidation number or conversion from an incompletely oxidized state to a completely oxidized state through oxidation. It is preferred that the metal in the metal oxide is any one selected from Ti, Fe, Ag, Cu, Ni, Al, Mg or Sb. Meanwhile, to facilitate the oxidation reaction in the presence of laser irradiation, preferably YAG laser irradiation, it is particularly preferred to use the metal oxide that undergoes a change in oxidation number or conversion from an incompletely oxidized state to a completely oxidized state through oxidation.

For example, a label coated with ink containing a pigment of black titanium monoxide (TiO) may undergoes oxidation reaction into titanium dioxide (TiO₂) under the laser irradiation. As a result, the laser irradiated portion develops a white color. Other metal oxides that undergo a change in color through the oxidation reaction under the laser irradiation include Fe₂O, Fe₂O, Cu₂O, Ag₂O, Al₂O, Mg₂O, etc. The letters or numbers printed on the label show different colors depending on the particular type of the metal. For example, it is possible to realize a red color by forming ferric oxide by the laser irradiation.

As described above, when the ink layer 12 is formed to have a multilayer structure, a pigment containing an oxide of any one metal selected from Cu, Fe, Al, Ni or Ag having high laser absorptivity is applied to saturation 2 ink layer. When such saturation 2 ink layer is formed by applying a metal oxide having high laser absorptivity, it is possible to realize an improved camouflaging effect, increased laser marking efficiency and various colors.

According to a preferred embodiment of the present invention, the ink layer 12 comprises the pigment in an amount of 25-50 wt % based on the total weight of the ink. When the pigment is used in an amount less than 25 wt %, it is not possible to realize a sufficiently clear color. On the other hand, when the pigment is used in an amount greater that 50 wt %, the marking efficiency may be degraded upon the laser irradiation. In this regard, it is more preferred that the pigment is used in an amount of 30-35 wt %.

To obtain uniform laser marking quality, it is necessary to control the particle size of the pigment particles. The pigment particles preferably have a particle size greater than 0 μm and equal to or less than 1 μm. When the pigment particles have a particle size greater than 1 μm, it is not possible to obtain sufficiently good marking quality. In other words, smaller particles in the above particle size range agglomerate in the ink layer 12 with a higher density, so that the laser irradiated portion is oxidized completely, resulting in a high-quality color and excellent marking quality. However, when the pigment particles have a particle size greater than 1 μm, it is not possible to obtain such good marking quality as described above.

In addition to the formation of the through-holes in the label according to the present invention, the label includes the ink layer as described above, thereby realizing excellent marking quality contrary to conventional laser marking films. Additionally, the label according to the present invention has improved cost efficiency, causes little change with time, and ensures good processability.

Moreover, the ink layer comprising a metal- or metal oxide-containing pigment according to the present invention provides a reinforced camouflaging effect, thereby preventing any colors other than the color of the letter or number from getting turbid by the underlying intermediate film 14 shown through the ink layer 12.

In step S1, the through-holes are formed only in the substrate film 11. On the contrary, it is possible to form the through-holes in both of the substrate film 11 and the ink layer 12, in step S2. The method for forming the through-holes is the same as described above.

Then, an adhesive layer 13 is formed on the bottom of the ink layer (S3).

The adhesive layer has a specific structure that can be completely removed upon the YAG laser irradiation without causing burrs (a phenomenon including degradation of the clearness of letters by the matte-finished layer, substrate film and ink layer remaining after incomplete carbonization under the laser irradiation) at the irradiation portion, and causes no problems at the contact portion between the ink layer and the adhesive layer.

The adhesive that may be used in the adhesive layer includes an acrylic adhesive. Such an acrylic adhesive maintains its adhesion even under the laser irradiation, and has printability, adhesion stability (thermal stability), chemical resistance and oil resistance. Additionally, it has heat resistance so that the burr generation can be inhibited to the highest degree.

The acrylic adhesive includes a low-viscosity adhesive or a high-viscosity adhesive. When using a low-viscosity acrylic adhesive, the adhesive is coated by way of a gravure coating process. When using a high-viscosity acrylic adhesive, the adhesive is coated by way of an “S” knife coating process (also referred to as comma coating). Herein, the acrylic adhesive is applied in an amount of 10-15 g/m² in a wet condition.

Then, an intermediate film 14 is formed on the bottom of the adhesive layer 13 (S4).

As the intermediate film 14, a highly heat resistant polyolefin film such as an oriented propylene film is used. It is preferred to use a polyethylene terephthalate film, polyimide film or polyethylene naphthalate film.

When such polyolefin films are used, it is possible to represent the color of the ink layer developed by the laser irradiation more clearly. For example, when the ink layer 12 develops a white color through the oxidation, a transparent film or milky white film is used as the intermediate film 14. In the case of laser marking, letters or colors can be seen from the portion to which the laser beams are irradiated. Therefore, the intermediate film 14 should have the same color as the color of the letters after undergoing a change in color through the oxidation caused by the laser irradiation, so that the letters can be seen clearly.

A preferred example of the intermediate film 14 includes a PET film having a thickness of 20-100 μm. When the intermediate film has a thickness less than 20 μm, the label may show decreased stiffness, resulting in generation of air bubbles between the surface of an adherent and the label, and, thereby, degradation of the adhesion between the label and the adherend. On the other hand, when the intermediate film has a thickness greater than 100 μm, a higher laser output is required to cut the label from the substrate film 11 to the adhesive layer 15, resulting in degradation of the lifespan of the corresponding laser system and an increase in the manufacturing cost.

Also, the intermediate film 14 may have through-holes. Particularly, the through-holes are formed in the intermediate film 14 first, and then the intermediate film 14 having the through-holes is formed on the bottom of the adhesive layer 13. Otherwise, the intermediate film 14 is formed first on the bottom of the adhesive layer 13, and then the through-holes are formed in the intermediated film 14.

It is a matter of course that the through-holes can be formed only in the intermediate film 14, while not forming the through-holes in the substrate film 11 or the substrate film 11 and the ink layer 12 in step S1 or S2.

Meanwhile, after the completion of steps S1-S4, i.e., after forming the intermediate film finally without forming the through-holes in the substrate film 11, the through-holes may be formed in the substrate film 11 and the intermediate film at the same time. The method for forming the through-holes is the same as described above.

In addition, as described above, a half cutting process may be further carried out after the completion of steps S4.

Then, a glutinous layer 15 is formed on the bottom of the intermediate layer 14 (S5).

To accomplish this, an acrylic tackifier is applied to one side of the intermediate film 13 by way of an “S” knife coating process to form the glutinous layer 15.

Meanwhile, the label according to a preferred embodiment of the present invention allows the glutinous layer 15 to have a relatively low level of initial adhesion (a lower level of adhesion as compared to the adhesion after heating as described hereinafter), so that the label can be easily detached from an adherent when a worker attaches the label at an undesired position by mistake. Additionally, the label shows an increased level of permanent adhesion after being attached to an adherent by heating the label at a predetermined temperature (80-90° C.). For example, in the case of a vehicle license label, it is possible to increase the permanent adhesion of the label, because the label attached to an adherend is heated naturally during use. Therefore, when one attempts to detach the label intentionally, the film is ruptured starting from the substrate film or the intermediate film.

Finally, a release film 16 is formed on the bottom of the glutinous layer 15 (S6).

Examples of the release film 16 that may be used in the present invention include a PET release film coated with silicone functioning as a release force modifier. Particularly, silicone is used as a base material, an epoxy-based silane crosslinker is used as a curing agent, and a platinum-containing catalyst is used as an additive.

Hereinafter, the present invention will be described in detail with reference to a test example. It is to be understood that the following example is illustrative only and the present invention is not limited thereto.

### Test Example

### Labels with Different Through-Hole Ratios

A substrate film (a PET film with a thickness of 80 μm) was coated with black TiO pigment-containing ink, and then the coated substrate film was laminated with a milky white PET film intermediate film) by using an acryl based adhesive to provide a label.

Then, through-holes were formed in the label from the intermediate film up to the substrate film (see FIG. 3).

As described above with reference to FIG. 4, a ratio of the total area of the surfaces of the through-hole inlets 30 to the area of the plane 35 of the film on which the through-hole inlets exist is defined as the through-hole ratio. Each label sample has a through-hole ratio of 1%, 5%, 10%, 20%, 25%, 26% or 30%. Herein, the surface of the through-hole inlet has a diameter greater than 0 μm and equal to or less than 100 μm.

Next, marking of desired information was carried out by using a laser (the portion subjected to marking underwent a change in color into a white color).

The appearance of each label sample was evaluated, with the naked eyes. Particularly, surface roughness and presence of white spot shapes (“white spot phenomenon”) caused by the through-holes were checked when viewed from the outermost layer of the black label. It is to be noted that more white spots appear and surface roughness increases as the through-hole ratio increases.

Meanwhile, the label should have chemical resistance, because a label contaminated with fat or oil may cause interlayer separation, resulting in loss of the information about the corresponding article. Therefore, the label was tested to investigate its chemical resistance. To perform the chemical resistance test, the label sample was dipped into a prepared solvent (51% toluene+50% gasoline) and was checked whether interlayer separation occurred or not.

The results are shown in the following Table 1. With reference to the symbols rep-resenting the chemical resistance in Table 1, “◯” means that no interlayer separation occurs in the whole label, “Δ” means that interlayer separation occurs partially in the label, and “X” means that interlayer separation occurs totally in the label. With reference to the symbols representing the appearance of the label in Table 1, “◯” means that a white spot phenomenon does not occur in the whole label and the label shows clean and smooth appearance with no surface irregularities, “Δ” means that a white spot phenomenon or surface roughness is observed partially in the label, and “X” means that both a white spot phenomenon and surface roughness are observed totally in the label.

TABLE 1

| | 1% | 5% | 10% | 15% | 20% | 25% | 26% | 30% |
|---|---|---|---|---|---|---|---|---|
| Appearance | ◯ | ◯ | ◯ | ◯ | ◯ | ◯ | Δ | X |
| Chemical Resistance | ◯ | ◯ | ◯ | ◯ | ◯ | ◯ | X | X |

As can be seen from the above test results, the label having a through-hole ratio greater than 25% exhibits interlayer separation and shows poor chemical resistance.

Additionally, the label having the through-holes formed starting from the substrate film up to the intermediate film with a through-hole ratio greater than 0% and equal to or less than 25% has excellent chemical resistance and appearance. In this case, gaseous materials generated upon the laser irradiation can be easily discharged from the label, so that the label shows excellent printability.

On the other hand, the label having the through-holes with a through-hole ratio greater than 25% shows poor appearance and chemical resistance.

Additionally, upon the laser irradiation, the substrate film having a high through-hole ratio undergoes interlayer separation at the outermost layer thereof by the heat, resulting in degradation of the printability of the label.

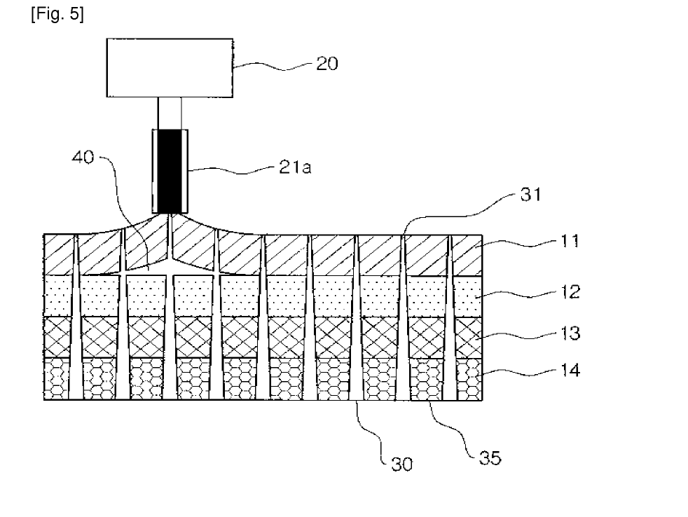

With reference to FIG. 5, one embodiment of the present invention is illustrated, wherein the through-hole ratio is excessively high so that an interlayer separation phenomenon 40 is caused on the outermost layer, i.e., the substrate film, upon the laser irradiation to the through-holes. As shown in FIG. 5, the label having a through-hole ratio greater than 25% causes a thermally induced interlayer separation phenomenon (40; a phenomenon different from the above-mentioned interlayer separation generated inside the label) at the outermost layer (i.e., substrate film 11).

As described above, the present invention related to a label that can be applied to not only vehicles, but also electronic appliances, semiconductors, medical instruments, etc., which are in need of follow-up management, in some aspects of preventing forgery of articles or controlling fidelity and quality of articles.

### INDUSTRIAL APPLICABILITY

The method for preparing the label according to the present invention causes no generation of defects, and shows an excellent production rate and work efficiency. Since the label obtained from the method comprises through-holes in the substrate film and the intermediate film, the label allows no possibility of forgery, and shows clear marking characteristics. In addition, the label has a simple structure and excellent printability and cost efficiency, causes no degradation of the quality with time, shows high chemical resistance and heat resistance, is free from various contaminants during use, and is provided with low initial adhesion but high permanent adhesion.

The invention has been described in detail with reference to preferred embodiments thereof. However, it will be appreciated by those skilled in the art that changes may be made in these embodiments without departing from the principles and spirit of the invention, the scope of which is defined in the accompanying claims and their equivalents.

1. A label comprising:
a substrate film; or a substrate film and an intermediate film,
wherein either or both of the substrate film and the intermediate film have through-holes.

2. A label comprising:
a substrate film;
an ink layer formed on the bottom of the substrate film;
an adhesive layer formed on the bottom of the ink layer;
an intermediate film formed on the bottom of the adhesive layer; and
a glutinous layer formed on the bottom of the intermediate film,
wherein either or both of the substrate film and the intermediate film have through-holes.

3. The label as set forth in claim 1, wherein a ratio of the total area of surfaces of the through-hole inlets is greater than 0% and equal to or less than 25% based on the area of the plane of the substrate film or intermediate film on which the through-hole inlets exist.

4. The label as set forth in claim 2, which further comprises a release film formed on the bottom of the glutinous layer.

5. The label as set forth in claim 2, wherein the ink layer undergoes a change in color when subjected to laser irradiation.

6. The label as set forth in claim 5, wherein the ink layer comprises a metal or metal oxide that undergoes a change in color through oxidation reaction by laser irradiation, wherein the metal or metal oxide undergoes a change in oxidation number or conversion from an incompletely oxidized state to a completely oxidized state through oxidation reaction by laser irradiation.

7. The label as set forth in claim 6, wherein the metal is Ti, Fe, Ag, Cu, Ni, Al, Mg or Sb.

8. The label as set forth in claim 2, wherein the intermediate film is transparent or has the same color as the laser marking portion of the ink layer, and is to be a color contrast layer for the portion other than the laser marking portion of the ink layer.

9. The label as set forth in claim 2, wherein either or both of the substrate film and the intermediate film are further subjected to half cutting.

10. The label as set forth in claim 2, wherein the substrate film is a matte-finished substrate film.

11. The label as set forth in claim 2, wherein the glutinous layer shows increased permanent adhesion by applying heat thereto at 80-90° C. after the label is attached to an adherend.

12. A method for preparing a label, comprising the steps of:
(i) forming through-holes in a substrate film;
(ii) forming an ink layer on the bottom of the substrate film having the through-holes;
(iii) forming an adhesive layer on the bottom of the ink layer;
(iv) forming an intermediate film on the bottom of the adhesive layer; and
(v) forming a glutinous layer on the bottom of the intermediate film.

13. The method as set forth in claim 12, wherein the through-holes are formed in the intermediate film before or after forming the intermediate film on the bottom of the adhesive layer in step (iv).

14. A method for preparing a label, comprising the steps of:
(i) providing a substrate film;
(ii) forming an ink layer on the bottom of the substrate film;
(iii) forming through-holes in the substrate film having the ink layer;
(iv) forming an adhesive layer on the bottom of the ink layer;
(v) forming an intermediate film on the bottom of the adhesive layer; and
(vi) forming a glutinous layer on the bottom of the intermediate film.

15. The method as set forth in claim 14, wherein the through-holes are formed in the intermediate film before or after forming the intermediate film on the bottom of the adhesive layer in step (iv).

16. A method for preparing a label, comprising the steps of:
(i) providing a substrate film;
(ii) forming an ink layer on the bottom of the substrate film;
(iii) forming an adhesive layer on the bottom of the ink layer;
(iv) forming an intermediate film having through-holes on the bottom of the adhesive layer; and
(v) forming a glutinous layer on the bottom of the intermediate film.

17. A method for preparing a label, comprising the steps of:
(i) providing a substrate film;
(ii) forming an ink layer on the bottom of the substrate film;
(iii) forming an adhesive layer on the bottom of the ink layer;
(iv) forming an intermediate film on the bottom of the adhesive layer; and
(v) forming a glutinous layer on the bottom of the intermediate film,
wherein through-holes are formed in both of the substrate film and the intermediate film after steps (i)-(iv).

18. The method as set forth in claim 12, wherein the through-holes are formed by using diamond particles, needles or brushes.
